(19) United States
(12) Patent Application Publication
(10) Pub. No.: US 2012/0244549 A1
(43) Pub. Date: Sep. 27, 2012

(54) Detection Method for Methyltransferase Enzymatic Activity

(75) Inventors: Robert G. Lowery, Belleville, WI (US); Matt Staeben, Belleville, WI (US); Tony A. Klink, Madison, WI (US)

(73) Assignee: BELLBROOK LABS, LLC, Madison, WI (US)

(21) Appl. No.: 13/429,066

(22) Filed: Mar. 23, 2012

Related U.S. Application Data
(60) Provisional application No. 61/467,826, filed on Mar. 25, 2011.

(51) Int. Cl. G01N 21/64

(52) U.S. Cl. 435/7.1

(57) ABSTRACT

This invention provides methods to determine the activity of methyltransferase enzymes which employ S-adenosylmethionine (SAM) as a substrate and transfer a methyl group to convert this substrate to S-adenosylhomocysteine (SAH), by measuring SAH conversion to AMP.

### CROSS-REFERENCE TO RELATED APPLICATIONS

The present Non-Provisional application claims the benefit of U.S. Provisional Patent Application No. 61/467,826, filed on Mar. 25, 2011, the disclosure of which is herein incorporated by reference in its entirety.

### STATEMENT REGARDING FEDERALLY SPONSORED RESEARCH OR DEVELOPMENT

This invention was made with United States government support under grant number R44 GM073290 awarded by the following government agency: National Institute of General Medical Sciences. The United States government has certain rights in this invention.

### BACKGROUND OF THE INVENTION

Methyltranferases (MTs) are a diverse family of enzymes that catalyze the transfer of a methyl group from S-adenosylmethionine (SAM) to amino, thiol, or hydroxyl groups of acceptor molecules, generating S-adenosylhomocysteine (SAH) as a donor product. Acceptor substrates include endogenous and xenobiotic small molecules, proteins, DNA and RNA, and lipids. MTs are generally named based on the nature of their acceptor substrates and the chemical moiety that is methylated; e.g., catechol-O-methyltransferase, protein arginine methyltransferase, RNA (guanine-7) methyltransferase (Table 1). There are over 40 MT entries in NCBI's OMIM database (omitting pseudogenes), and recent sequence searching efforts are revealing more potential members of the family. They are structurally diverse, ranging in size from 25 to 200 kDa, with much of the variability within non-catalytic domains involved in targeting to substrates or cell compartments.

MTs play diverse and important roles in cellular metabolism and signal transduction (Table 1), ranging from control of neurotransmitter levels to epigenetic regulation of transcription. As in the case of other types of covalent modification such as phosphorylation, methylation is used to regulate the activity, location and stability of biomolecules, thus MTs are opportune points for therapeutic intervention.

TABLE 1
A partial listing of human methyltranferases proteins grouped by their specificity for acceptor substrates
with known functions and links to diseases. The total number of human MT genes is estimated to be
between 50 and 100 (R. Weinshilboum, personal communication).

| Acceptor | MT Enzymes (# genes) | Key Functions | Disease Links |
|---|---|---|---|
| Small | Thiopurine MT | Metabolism of immunosuppressant drugs | Acute Leukemia |
| molecule | | | Organ Transplants |
| | Catechol MT | Inactivation of dopamine, epinephrine, | Parkinson's Disease |
| | | norepinephrine and catechol estrogens | Alzheimer's Disease |
| | | | Breast Cancer |
| | Phenylethanolamine MT | Epinephrine production | Alzheimer's Disease |
| | | | Hypertension |
| | Nicotinamide MT | Inactivation of nicotinamide | Parkinson's Disease |
| | Histamine MT | Inactivation of Histamine | Psychiatric and |
| | | | Neurodegenerative Diseases |
| Lipid | Phosphatidylethanolamine MT | Choline Synthesis | |
| Protein | Protein Arginine MTs | Regulation of transcription factors, | Breast, prostate cancer, |
| | | coactivators and histones | inflammation |
| | Histone Lysine MTs | Regulation of Transcription - methylation | Various cancers |
| | | of histones | |
| | Isoprenylcysteine Carboxyl MT | Protein targeting to membrane - | Various cancers, |
| | | heterotrimeric and small G proteins, | Inflammatory diseases |
| | Protein Phosphatase | Enzyme regulation - Phosphatase 2A | Alzheimer's disease |
| | (Leucine) MT | | |
| | Isoaspartate MT | Protein Repair - Histones | |
| DNA | DNA (Cytosine-5) MT | Epigenetic Regulation - Tumor Suppressor | Various cancers: acute |
| | | Gene Silencing | leukemia, breast cancer |
| | O6-Methylguanine-DNA MT | DNA Repair | Various cancers |

Methylation affects a diverse spectrum of biomolecules and impacts a corresponding diversity of pathologies. The methylation of neurotransmitters and neuromodulators plays an important, but poorly understood role in neurodegenerative disease pathways, and the involvement of protein and DNA methylation in CNS diseases, including cancer, is an active area of investigation. The therapeutic relevance of methylation has been clinically validated for Parkinson's disease, leukemia and for drug metabolism, yet only a small fraction of the potential MT targets have been exploited to date. Below we describe the shortcomings of current assay methods for MTs, and how the instant invention will accelerate the integration of methylation biology into drug discovery programs.

Automated High-Throughput Screening (HTS) assays are the paradigm for identifying small molecule inhibitors in drug discovery programs. HTS requires assays that can be performed entirely in multiwell plates with few manipulations. The preferred format is a homogenous, or “mix and read” assay that allows detection in solution with no manipulations after the reaction is stopped and detection reagents are added. Unfortunately, the most widely used method for measuring MT activity is still quantification of radioactive methyl conjugate produced from radiolabeled SAM. The radiolabeled methyl conjugates—whether small molecules, protein or DNA—are separated from residual labeled SAM and quantified by liquid scintillation counting or scanning of autoradiograms. The need for a post-reaction separation step such as high pressure liquid chromatography (HPLC), filter binding, or gel electrophoresis to isolate the reaction products makes the methods cumbersome and complicates their incorporation into an automated HTS platform. In addition, the use of radioassays for HTS is decreasing because of the high costs of radioactive waste storage and disposal. Non-radioactive detection methods have recently been developed for DNA methyltransferases, but the detection methods require digestion of DNA with restriction enzymes and the method is not applicable to other classes of MT's.

### BRIEF DESCRIPTION OF THE DRAWINGS

FIG. 1 shows Methyltransferase (MT) assay platform which can detect activity from the entire family of enzymes. Traditionally, an assay is developed for each specific methyltransferase enzyme. The instant invention describes an enzyme detection assay that would work for any methyltransferase enzyme.

FIG. 2 shows one embodiment of the coupled enzyme reactions described in the instant invention.

FIG. 3 shows one embodiment of the detection method of the instant invention where methyltransferase activity can be monitored by the conversion of the universal product of the reaction, SAH, to AMP. Specifically, SAH produced by the target methyltransferase is converted to AMP by coupling enzymes which allows homogenous fluorescent detection using an AMP/GMP detection assay. AMP levels are measured through the use of an antibody to AMP and the coincident release of a fluorescent tracer molecule.

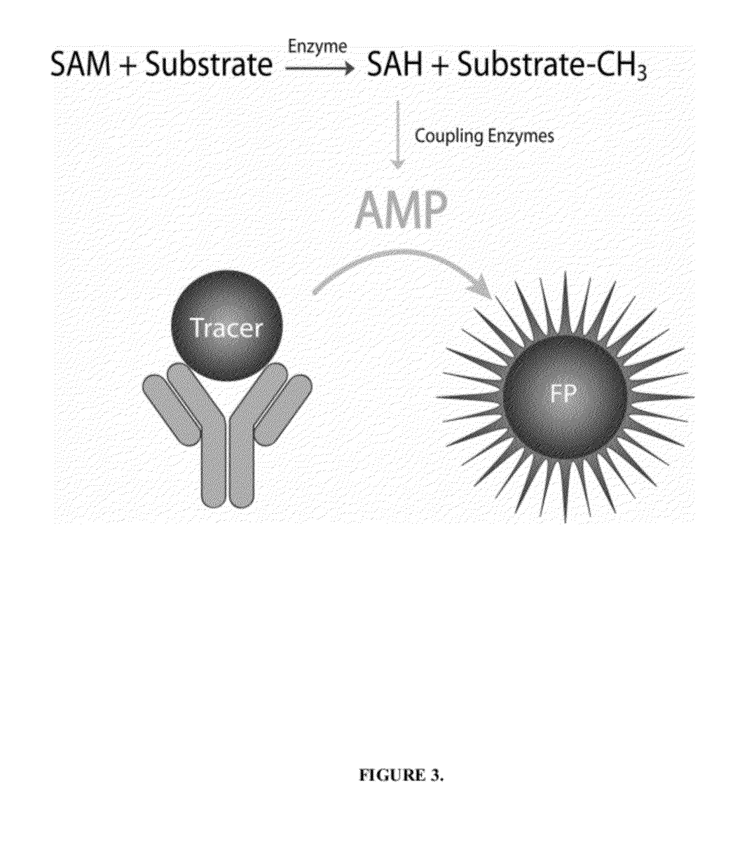

FIG. 4 illustrates the measurement of three different MT activities with the instant invention. The graph shows the relative increase in detectable enzymatic activity with increasing amounts of enzyme added.

FIG. 5 illustrates the ability of this embodiment of the instant invention to detect the methylation of both peptide and full-length protein methylation substrates. G9a histone methyltransferase reactions were performed with native protein (1 μM) or peptide substrates (10 μM or 100 μM) at 1 μM SAM. Reactions were processed as described in FIG. 4.

FIG. 6 shows dose response curves for G9a methyltransferase sensitivity with known inhibitors (chaetocin and sinefungin) and illustrate the ability of this embodiment of the instant invention to measure the effects of inhibitors of methyltransferase activity. The 1050 values for sinefungin and chaetocin were 4.7 and 770 μM, respectively. The G9a enzyme reactions progressed to 25% SAM conversion with Z′>0.5.

### DETAILED DESCRIPTION OF THE INVENTION

Limitations of the Current Technology.

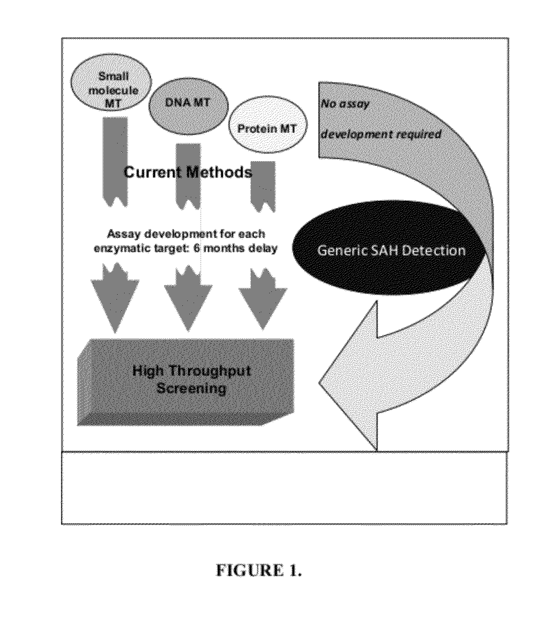

The dominant method of measuring methyltransferase reactions is quantification of radioactive methyl conjugates produced from radiolabelled SAM. The radioactive method is expensive, creates hazardous waste disposal problems, and requires regulatory oversight. Most of the competing assays also are not generic (FIG. 1). These non-flexible assays require development of different assay conditions for every specific methyltransferase. This is a serious disadvantage for two reasons: it requires more time and expense to develop new assays for each methyltransferase target and, more importantly, it's difficult to compare the effect of potential drug molecules across the methyltransferase family. These comparisons are a vital step in the drug discovery process because the drug candidate needs to specifically inhibit the target enzyme without affecting other enzymes if adverse side effects are to be avoided. The instant invention allows the drug discovery scientist to test a drug candidate against a panel of related methyltransferases using the same reagents so that results can be directly compared.

Solutions Provided by the Instant Invention.

Because of the problems with the level of the current technology, pharmaceutical companies are looking for a robust, non-radioactive and generic method of screening methyltransferases. The described invention overcomes all of the shortcomings of the existing assay methods and offers a unique combination of advantages:

Simple—one step, mix-and-read format

Universal—any methyltransferase with any substrate

Sensitive—high quality signal generated at very low levels methyltransferase enzyme

Adaptable—this assay will be offered in two of the most popular read out formats

The claimed invention is a generic methyltransferase assay method using fluorescent immunodetection of AMP, which is formed from the MT reaction product S-adenosylhomocysteine in a dual enzyme coupling step. This combination of a coupled enzyme reaction and a detection system for the resultant nucleotide (or other small molecule) product characterizes this invention.

The detection range of the assay and its suitability for HTS, including stability of reagents following dispensing and after addition to reactions was investigated. In addition, the use of the assay for measuring inhibitor potencies was examined with histone methyltransferase (HMT) G9a (see examples). By combining a novel enzymatic coupling step with the well characterized and patented Transcreener® AMP/GMP detection system, we have developed a robust high throughput screening (HTS) assay for HMTs which should be broadly applicable to other types of methyltransferases as well.

Coupled Enzyme Reaction.

Methytransferases catalyze the reaction of a non-methylated substrate plus SAM to the products of a methylated substrate plus SAH. This methylation reaction is a ubiquitous covalent modification used to control the function of diverse biomolecules including hormones, neurotransmitters, xenobiotics, proteins, nucleic acids and lipids, which all serve as substrates (FIG. 1). A mechanism which is robust, non-radioactive and universally detects this enzymatic activity satisfies a long-felt need in the field.

One accomplished in the field would recognize that one method to universally detect this enzymatic activity would be to measure the production of SAH. As the direct detection of SAH has proven challenging, a coupled enzyme assay can be devised to convert SAH to another product which is easily detectable.

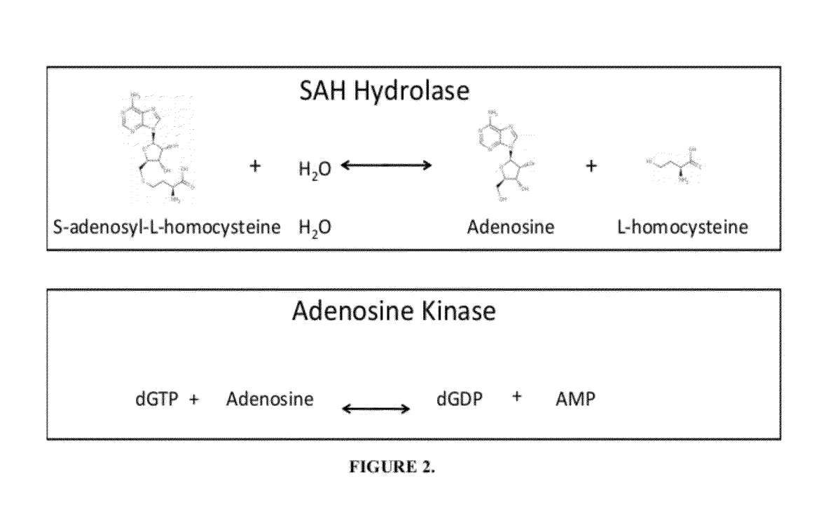

In one embodiment the coupling enzymes used would convert the SAH produced in the MT reaction to AMP for detection (FIG. 2). A first enzyme, such as SAH Hydrolase could be used to convert SAH to adenosine and L-homocysteine. A second enzyme, such as Adenosine Kinase could then be used to convert the adenosine plus (d)GTP to (d)GDP and AMP. AMP is then detectable in this embodiment.

A further embodiment of this enzymatic conversion could utilize a variety of substrates to serve as the phosphate group donor in the AK step. This enzyme has kinase activity to varying degrees on all tri- and di-phosphate nucleotides and their deoxy-counterparts. Any of these phosphate donors could be used within this reaction step.

A further embodiment of the invention would utilize SAM depletion mechanisms prior to the coupled enzymatic step in an effort to reduce any potentially interfering background activity due to crossreactivity of the SAHH with SAM MT substrate. A list of enzymes to reduce or eliminate SAM levels prior to the coupled assay could include, but is not limited to, SAM Hydrolase, Fluorinase and 1-Aminocyclopropane-1-carboxylic acid Synthase (ACC Synthase).

In other embodiments, it would be obvious to one skilled in the art that there would be multiple mechanisms for converting SAH into a detectable product. The detectable product need not be AMP. This final detectable product could be any nucleotide, nucleoside, or other small molecule.

Product Detection.

Once a detectable product is available there would be a wide variety of detection methods to quantitate the levels of the initial MT enzymatic activity.

In one embodiment the invention will provide a robust screening platform for the entire MT superfamily. It utilizes a universal HTS assay platform that relies on immunodetection of the invariant reaction product of a group transfer reaction (FIG. 1); SAH for methyltransferases. This enables screening of all of the enzymes within an enzyme superfamily using the same assay and reagents. This embodiment includes a homogenous or “mix-and-read” assay platform that can be formatted for several detection modes, including the most common fluorescence modes currently used for HTS, such as fluorescence polarization (FP) and time-resolved fluorescent resonance energy transfer (TR-FRET).

This embodiment would use an FP readout because it is the simplest fluorescent method for measuring competitive binding. FP is used to study molecular interactions by monitoring changes in the apparent size of fluorescently-labeled or inherently fluorescent molecules. When a small fluorescent molecule—the tracer—is excited with plane-polarized light, the emitted light is largely depolarized because the molecule rotates rapidly in solution during the fluorescence event (the time between excitation and emission). Binding of the tracer to an antibody increases its effective molecular volume and slows its rotation sufficiently to emit more light in the same plane in which it was excited. This embodiment relies on a competitive fluorescence polarization immunoassay (FPIA) in which SAH produced from the MT reaction competes with the tracer (fluorescently tagged SAH) for binding to an antibody. In this format, the starting polarization is high, and decreases as the reaction proceeds. FP is broadly accepted in HTS, with FPIA's for phosphopeptide detection already in extensive use for kinases.

In other embodiments, it would be obvious to one skilled in the art that there would be multiple mechanisms for detecting the accumulated product at the completion of the coupled enzyme reaction. These methods could include, but are not limited to, luminescence, FRET, TR-FRET, electrophoretic separation, reduced protease sensitivity, radioassay, and binding procedures (such as antibody or immobilized metal) followed by detection with some other system.

### EXAMPLES

### Histone Methyltransferase Activity Detection

Histone methyltransferases (HMTs) are currently of high interest as drug targets because of their role in epigenetic regulation, however most HMT assay methods are either not amenable to an HTS environment or are applicable to a limited number of enzymes. One embodiment of the instant invention is a generic methyltransferase assay method using fluorescent immunodetection of AMP, which is formed from the MT reaction product S-adenosylhomocysteine in a dual enzyme coupling step. The assay format shows >100 mP signal with Z′>0.5 at initial rate conditions for 1 μM to 50 μM SAM. The suitability for HTS is demonstrated using 384-well plates with >16 hour deck (prior to plate addition) and signal (stability after plate addition) stability at room temperature. The activity of three HMTs (G9a, Set7/Set9, SUV39H1) were followed with using histone H3 peptides while G9a activity was assessed using both peptide and full length histone H3. In addition, inhibitor potencies were determined with G9a HMT. By combining a novel enzymatic coupling step with an AMP2/GMP2 detection assay, we have developed a robust HTS assay for HMTs which should be broadly applicable to other types of methyltransferases as well.

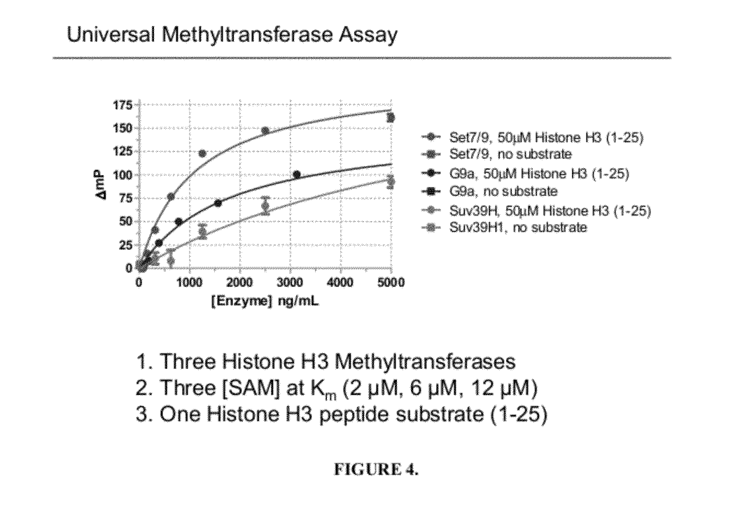

Enzyme titrations shown in FIG. 4 demonstrate dose responses for three HMTs, Set7/Set9, G9a, and SUV39H1 using Histone H3 peptide (1-25) at the SAM Km (6 μM, 2 μM, and 12 μM respectively). HMT reactions were run for 60 minutes followed by addition of quench and detection reagents including the SAM-SAH coupling enzyme mixture and the Transcreener® AMP2/GMP2 Assay monoclonal antibody and tracer.

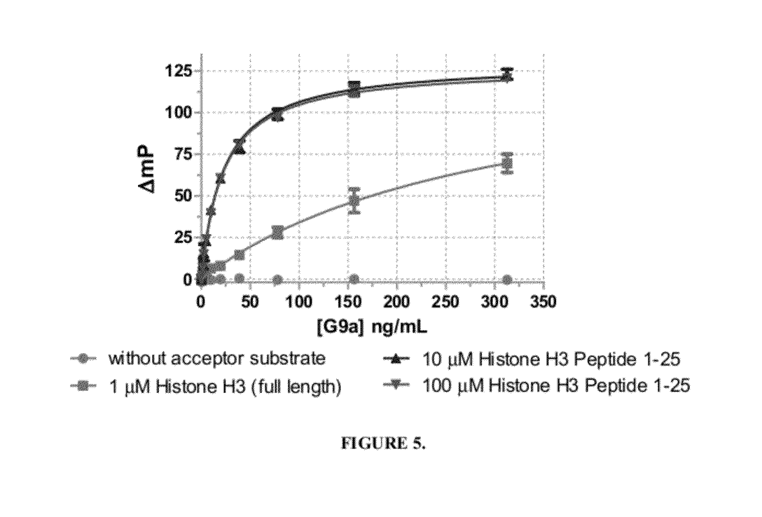

This embodiment of the instant invention is able to detect the methylation of both peptide and full-length protein methylation substrates. G9a histone methyltransferase reactions shown in FIG. 5 were performed with native protein (1 μM) or peptide substrates (10 μM or 100 μM) at 1 μM SAM. Reactions were processed as described in FIG. 4.

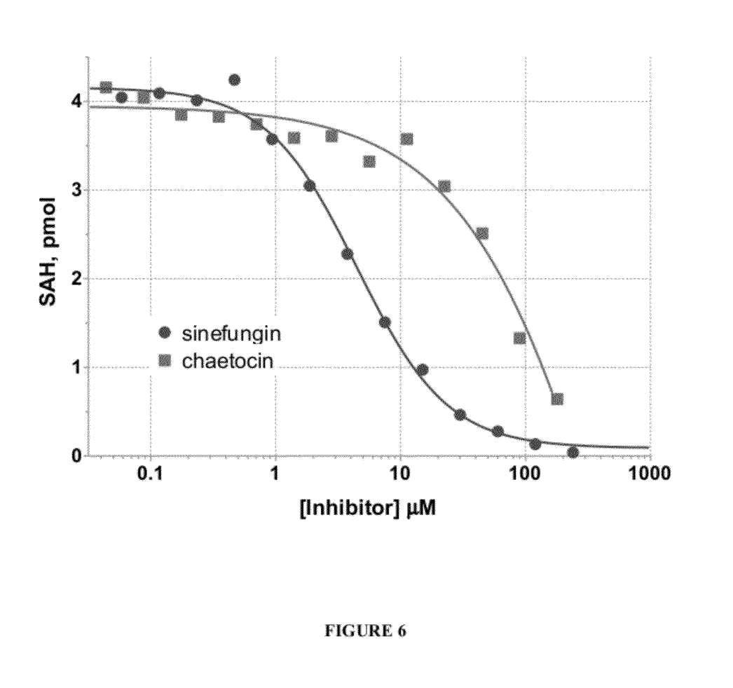

This embodiment of the instant invention is able to demonstrate the activity of inhibitors of methylation reactions as shown in FIG. 6. Dose response curves were generated for G9a methyltransferase sensitivity with known inhibitors (chaetocin and sinefungin). The IC50 values for sinefungin and chaetocin were 4.7 and 770 μM, respectively. The G9a enzyme reactions progressed to 25% SAM conversion with a Z′>0.5.

While specific embodiments of the subject matter have been discussed, the above specification is illustrative and not restrictive. Many variations will become apparent to those skilled in the art upon review of this specification and the claims below. The full scope of the invention should be determined by reference to the claims, along with their full scope of equivalents, and the specification, along with such variations.

All publications and patents mentioned herein are hereby incorporated by reference in their entirety as if each individual publication or patent was specifically and individually indicated to be incorporated by reference.

1. A method of detecting the presence or absence of or determining the amount of S-adenosylhomocysteine (SAH) in a solution, comprising:
a) converting SAH in the solution to a nucleoside or nucleotide using an enzyme or enzymes that are capable of converting SAH to a detectable molecule; and
b) detecting the presence or absence of or determining the amount of the nucleoside or nucleotide produced using a detection method.

2. The method of claim 1 wherein the nucleotide is adenosine monophosphate (AMP).

3. The method of claim 1 wherein the detection method utilizes a specific binding molecule.

4. The method of claim 2 wherein the detection of AMP utilizes any molecule which binds to AMP with greater affinity than it binds to a di- or tri-phosphate nucleotide.

5. The method of claim 2 wherein the conversion of SAH to AMP in (a) is accomplished with the coupled enzyme reaction of SAH hydrolase and adenosine kinase.

6. The method of claim 2 wherein the detection of AMP utilizes an antibody which binds to AMP with greater affinity than it binds to a di- or tri-phosphate nucleotide.

7. The method of claim 6 further comprising the detection of AMP-antibody binding with a competitive fluorescent polarization assay format.
